(19) United States
(12) Patent Application Publication
(10) Pub. No.: US 2014/0355595 A1
(43) Pub. Date: Dec. 4, 2014

(54) METHOD AND APPARATUS FOR STRATEGICALLY MONITORING IS-2000 1X ANCILLARY TIMING PARAMETERS

(71) Applicant: QUALCOMM Incorporated, San Diego, CA (US)

(72) Inventor: Troy Russell CURTISS, Erie, CO (US)

(21) Appl. No.: 13/904,850

(22) Filed: May 29, 2013

(51) Int. Cl. H04W 56/00

(52) U.S. Cl. CPC H04W 56/0015
USPC 370/350

(57) ABSTRACT

Various aspects of the present disclosure provide an IS 2000 1x mobile station that is configured to strategically monitor a sync channel message for updates on ancillary information such as daylight savings time change, time zone change, and leap second change. In one aspect, a mobile station autonomously monitors sync channel in accordance with location information at a time independently determined by the mobile station; and updates one of a daylight savings time change, a time zone change, or a leap second change in accordance with a sync channel message on the sync channel. Other aspects, embodiments, and features are also claimed and described.

### TECHNICAL FIELD

Aspects of the present disclosure relate generally to wireless communication systems, and more particularly, to IS-2000 wireless communication systems.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the IS-2000 1x network (or 1xRTT), which belongs to the CDMA2000 standard supported by the 3rd Generation Partnership Project 2 (3GPP2) group. Another multiple access networks is UMTS Terrestrial Radio Access Network (UTRAN). CDMA2000 1xEV-DO, also referred to as EV-DO or EV, uses multiplexing techniques including code division multiple access (CDMA) as well as time division multiple access (TDMA) to maximize both individual user's throughput and the overall system throughput. It is standardized by 3GPP2 as part of the CDMA2000 family of standards.

As the demand for mobile broadband access continues to increase, research and development continue to advance the CDMA2000 technologies not only to meet the growing demand for mobile broadband access, but to advance and enhance the user experience with mobile communications. For example, it is desirable to improve how ancillary timing information is monitored by a mobile station.

### BRIEF SUMMARY OF SOME SAMPLE EMBODIMENTS

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the present disclosure are directed to an IS 2000 1x mobile station that is configured to strategically monitor a sync channel message for updates on ancillary information such as daylight savings time change, time zone change, and leap second change. In one aspect, the disclosure provides a method of wireless communication operable at a mobile station utilizing IS-2000 1x. The method includes: autonomously monitoring a sync channel in accordance with location information at a time independently determined by the mobile station; and updating one of a daylight savings time change, a time zone change, or a leap second change in accordance with a sync channel message on the sync channel.

Another aspect of the disclosure provides a method of wireless communication operable at a mobile station utilizing IS-2000 1x. The method includes: autonomously monitoring a sync channel in accordance with location information, concurrent with a monitoring of at least one of a paging channel or a traffic channel; and updating one of a daylight savings time change, a time zone change, or a leap second change in accordance with a sync channel message on the sync channel.

Another aspect of the disclosure provides a mobile station for wireless communication utilizing IS-2000 1x. The mobile station includes: means for autonomously monitoring a sync channel in accordance with location information at a time independently determined by the mobile station; and means for updating one of a daylight savings time change, a time zone change, or a leap second change in accordance with a sync channel message on the sync channel.

Another aspect of the disclosure provides a mobile station for wireless communication utilizing IS-2000 1x. The mobile station includes: means for autonomously monitoring a sync channel in accordance with location information, concurrent with a monitoring of at least one of a paging channel or a traffic channel; and means for updating one of a daylight savings time change, a time zone change, or a leap second change in accordance with a sync channel message on the sync channel.

Another aspect of the disclosure provides a computer program product including a computer-readable storage medium that includes code for causing a mobile station utilizing IS-2000 1x to: autonomously monitor a sync channel in accordance with location information at a time independently determined by the mobile station; and update one of a daylight savings time change, a time zone change, or a leap second change in accordance with a sync channel message on the sync channel.

Another aspect of the disclosure provides a computer program product including a computer-readable storage medium that includes code for causing a mobile station utilizing IS-2000 1x to: autonomously monitor a sync channel in accordance with location information, concurrent with a monitoring of at least one of a paging channel or a traffic channel; and update one of a daylight savings time change, a time zone change, or a leap second change in accordance with a sync channel message on the sync channel.

Another aspect of the disclosure provides a mobile station for wireless communication utilizing IS-2000 1x. The mobile station includes: at least one processor; a communication interface coupled to the at least one processor; and a memory coupled to the at least one processor. The at least one processor is configured to: autonomously monitor a sync channel in accordance with location information at a time independently determined by the mobile station; and update one of a daylight savings time change, a time zone change, or a leap second change in accordance with a sync channel message on the sync channel.

Another aspect of the disclosure provides a mobile station for wireless communication utilizing IS-2000 1x. The mobile station includes: at least one processor; a communication interface coupled to the at least one processor; and a memory coupled to the at least one processor. The at least one processor is configured to: autonomously monitor a sync channel in accordance with location information, concurrent with a monitoring of at least one of a paging channel or a traffic channel; and update one of a daylight savings time change, a time zone change, or a leap second change in accordance with a sync channel message on the sync channel.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a conceptual diagram illustrating an IS-2000 1x communications system.

FIG. 2 is a diagram illustrating the structure of a protocol architecture used by IS-2000 1x from the perspective of a mobile station.

FIG. 3 is a conceptual diagram illustrating the top-level states and their transitions at a mobile station utilizing IS-2000 in accordance with aspects of the disclosure.

FIG. 4 is a diagram illustrating four substates of an initialization state in IS-2000.

FIG. 5 is a diagram illustrating some fields of a sync channel message in IS-2000.

FIG. 6 is a flow chart illustrating a process for updating daylight savings time at a mobile station in accordance with an aspect of the disclosure.

FIG. 7 is a flow chart illustrating a process for updating local time zone information at a mobile station in accordance with an aspect of the disclosure.

FIG. 8 is a conceptual diagram illustrating a mobile station configured to monitor a sync channel concurrent with a monitoring of a paging channel and/or a traffic channel in accordance with an aspect of the disclosure.

FIG. 9 is a block diagram illustrating an example of a hardware implementation for a mobile station employing a processing system in accordance with an aspect of the disclosure.

FIG. 10 is a flowchart illustrating a method of wireless communication operable at a mobile station utilizing IS-2000 1x in accordance with an aspect of the disclosure.

FIG. 11 is a flowchart illustrating a method of wireless communication operable at a mobile station utilizing IS-2000 1x in accordance with an aspect of the disclosure.

FIG. 12 is a drawing illustrating a timeline for autonomously monitoring a sync channel utilizing IS-2000 1x in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

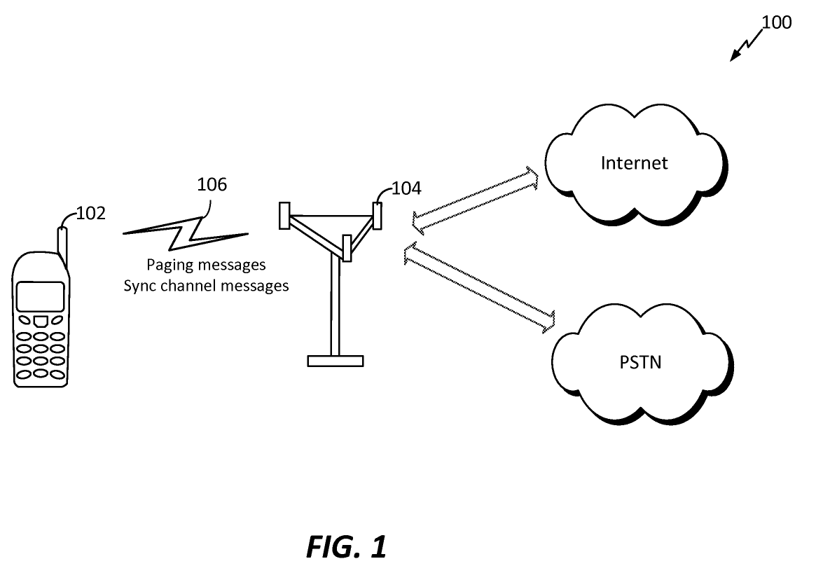

FIG. 1 is a conceptual diagram illustrating an IS-2000 1x communication system 100. A mobile station (MS) 102 (as known as an access terminal) can wirelessly communicate with a base station (BS) 104 (e.g., a base transceiver system). In operation, various messages 106 including paging messages and sync channel messages are communicated between the MS 102 and the BS 104. While FIG. 1 only shows one BS 104, the IS-2000 1x system 100 may include a number of BSs 104 each providing network access in one of a number of partially overlapping geographic areas in which the MS 102 may be located. The MS 102 may access an IP network (e.g., Internet) or a circuit-switched network (e.g., PSTN) via the BS 104.

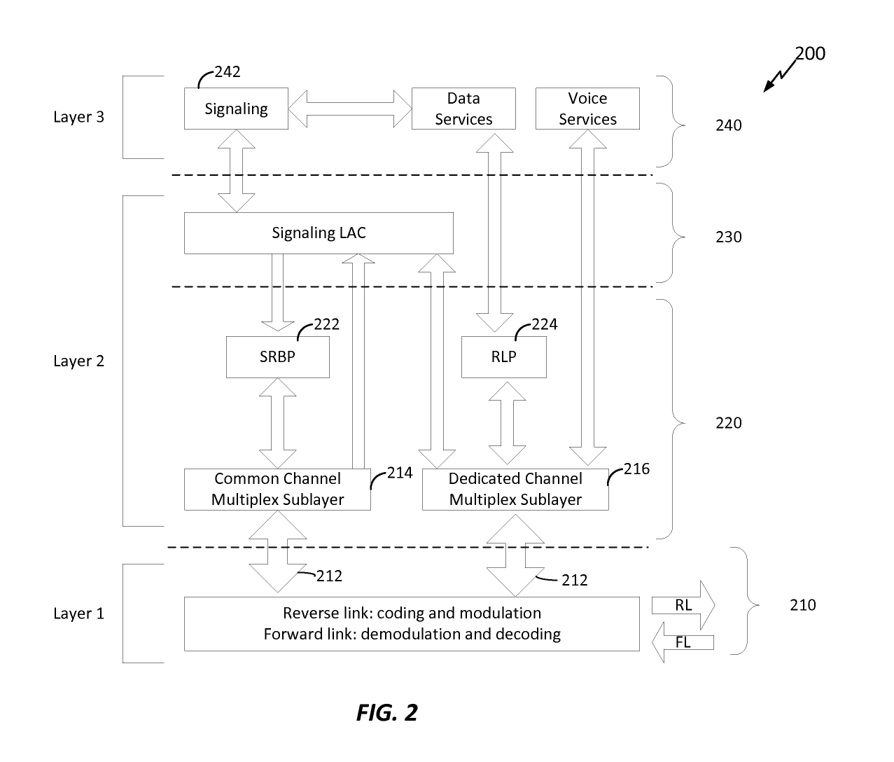

FIG. 2 shows the structure of a protocol architecture 200 used in IS-2000 from the perspective of a mobile station (e.g., MS 102). The protocol is divided into three different layers (layer 1, 2, and 3). These layers include a physical layer 210 (layer 1), a medium access control (MAC) sublayer 220 (layer 2), a signaling link access control (LAC) sublayer 230 (layer 2), and an upper layer 240 (layer 3).

The physical layer 210 is responsible for transmitting (RL) and receiving (FL) bits over a physical medium (e.g., over the air). For example, this layer may convert bits into waveforms with suitable modulation to enable their transmission wirelessly via a suitable air interface. The physical channels 212 are the communication paths between the physical layer 210 and the common/dedicated channel multiplex sublayers (214/216).

The MAC sublayer 220 controls higher layers' access to the physical medium that is shared among different users. In IS-2000, the MAC sublayer 220 manages the access of different users to the shared air interface. The logical channels are the communication paths between the common/dedicated channel multiplex sublayers (214/216) and the higher layer entities. The MAC sublayer 220 includes four different entities: SRBP 222, RLP 224, common channel multiplex sublayer 214, and dedicated channel multiplex sublayer 216. The common channel multiplex sublayer 214 performs the mapping between the logical common channels (channels that are shared among multiple users) and the physical common channels. The dedicated channel multiplex sublayer 216 performs the mapping between the logical dedicated channels (channels that are dedicated to specific users) and the physical dedicated channels. The SRBP entity 222 handles common-channel signaling (as opposed to dedicated-channel signaling) and the RLP entity 224 handles user information that is packetized in nature.

The signaling LAC sublayer 230 is responsible for the reliability of signaling (or overhead) messages that are exchanged. The LAC sublayer 230 performs a set of functions that ensure the reliable delivery of signaling messages. The upper layer 240 carries out overall control of the IS-2000 system such as processing all and originating new signaling messages. The signaling entity 242 (layer 3) controls the operation of the entire IS-2000 system. For example, the signaling entity 242 controls and executes functions that are used for the setup, maintenance, and tear down of a call following state transitions defined in the IS-2000 standard.

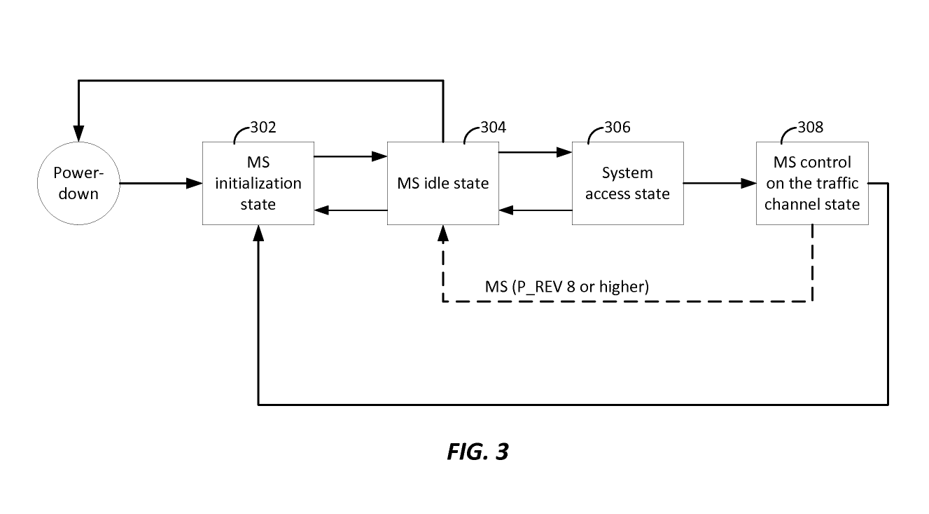

FIG. 3 is a diagram conceptually illustrating the top-level states and their transitions at a mobile station utilizing IS-2000. At the top level, the IS-2000 standard specifies four states: a mobile station initialization state 302, a mobile station idle state 304, a system access state 306, and a mobile station control on the traffic channel state 308. After power up, the MS 102 enters the MS initialization state 302. After a call is finished in the MS control on the traffic channel state 308, the MS 102 returns to the initialization state 302. While in the initialization state 302, the MS 102 selects and acquires a system. After the MS 102 acquires the system, it enters MS the idle state 304 where the MS 102 monitors messages from a BS 104.

The MS 102 remains in the MS idle state 304 until it receives a message (e.g., on the forward common signaling channel (f-csch)), originates a call, or performs registration (e.g., on the reverse common signaling channel (r-csch)). If any one of these three events occurs, then the MS 102 enters the system access state 306 where it may send messages on the r-csch and receives messages on the f-csch. If call origination is successful, the MS 102 is directed to a traffic channel by the BS 104, in which case the MS 102 enters the MS control on the traffic channel state 308. In this state, the MS 102 communicates with the BS 104 using the traffic channel.

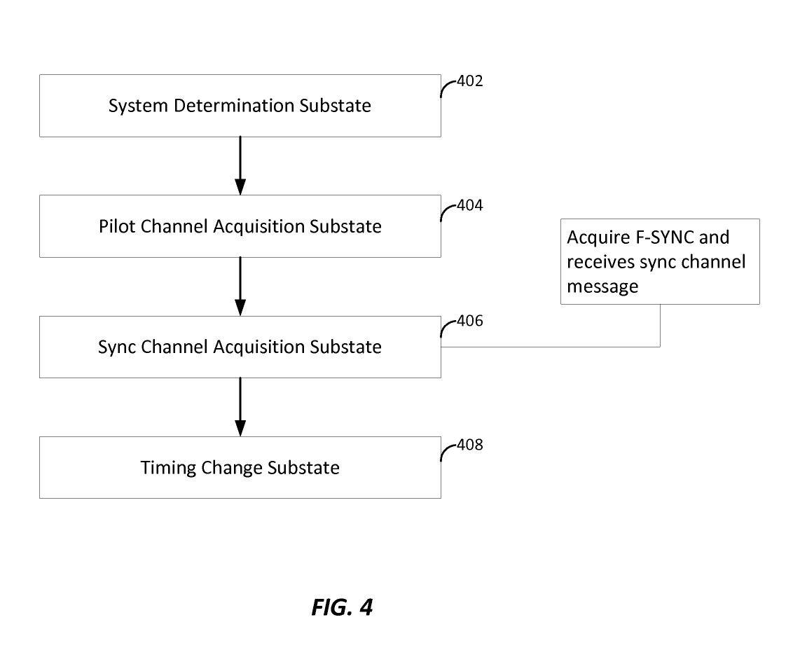

There are events that can cause the MS 102 to return to a previous state. For example, if the MS 102 loses the paging channel, forward common control channel, or broadcast control channel, then the MS 102 transitions from the MS idle state 304 back to the MS initialization state 302 to reacquire the system or to acquire another system. In addition, if the MS 102 performs a registration without making a call, it returns from the system access state 306 back to the MS idle state 304. Referring to FIG. 4, in the MS initialization state 302, the MS 102 goes through four substates in sequence: a system determination substate 402; a pilot channel acquisition substate 404; a sync channel acquisition substate 406; and a timing change substate 408.

In the sync channel acquisition substate 406, the MS 102 proceeds to acquire the sync channel (F-SYNC) and receives a sync channel message 106. The MS 106 obtains the system timing information, such as the pilot PN offset, the system time, and long code state, from the sync channel message. These enable the MS 102 to sync up its long PN code and to acquire subsequent common signaling channels (e.g., paging channel or forward common control channel) later. In addition, the MS 102 also obtains system configuration information, such as the minimum protocol revision level supported by the base station and whether or not the base station supports broadcast control channel, from the sync channel message.

It is currently possible to provision an IS-2000 1x mobile station (e.g., MS 102) to protocol revision (P_REV) 8 or higher. Regardless of the network's P_REV, if the mobile's P_REV is 8 or higher, it will always transition from the traffic channel state 308 back to the MS idle state 304, without going through a full network acquisition cycle. Due to not going through the full acquisition cycle, the F-SYNC message is not used and not received. Taking this fact into account with ubiquitous IS-2000 1x network coverage, a MS may not receive and read the F-SYNC message for a protracted amount of time. This is normally desirable, but it does open the MS to being blind to changing ancillary information present typically in the F-SYNC message. Some examples of the ancillary information are leap-seconds (rarely updated), daylight savings indicator (updated twice per year), and local time zone offset (update rate depended upon mobility). Therefore, the application layers of the MS may get out of sync with daylight savings time, local time zone, and leap-second changes, if in constant-coverage (i.e., not transitioning to the MS initialization state 302 for an extended period of time).

Various aspects of the present disclosure propose to modify the current IS-2000 1x protocol stack at an MS 102 such that it strategically monitors the sync channel message (e.g., messages 106) for updates on the above-described ancillary information present. Here, the MS 102 autonomously retrieves the sync channel message at a time independently determined by the MS 102 in such a way that may lead to conservation of mobile station power, without sacrificing page reception performance. For example, the MS 102 may schedule the sync channel message monitoring to occur immediately after a paging slot/interval, so that missing pages may be reduced or avoided. That is, the MS 102 retrieves the sync channel message at a predetermined schedule independently determined by the MS 102.

In some examples, while the MS 102 is in the idle state 304, it may monitor and retrieve the sync channel without going through pilot channel acquisition again. For example, the MS 102 may bypass the system determination substate 402 and pilot channel acquisition substate 404 and go straight to reading the sync channel, because the MS 102 already has working network timing information. In some examples, the MS 102 may jump directly back to the sync channel acquisition substate, retrieve the sync channel message, and bypass timing change substate 408 upon returning to the regular idle/sleep mode.

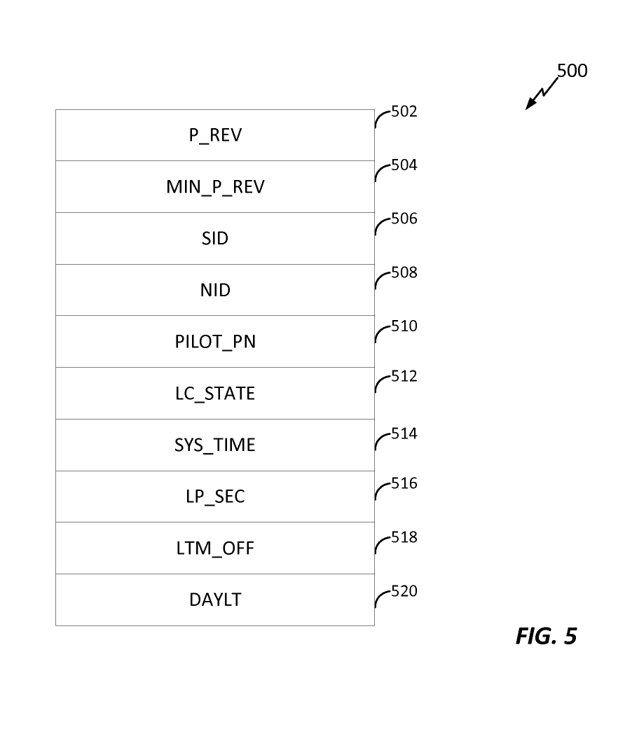

FIG. 5 is a drawing illustrating some fields of a sync channel message 500 in IS-2000. The field 502 (P_REV) indicates the protocol revision level. The field 504 (MIN_P_REV) indicates the minimum protocol revision level. The base station (e.g., BS 104) sets this field to prevent mobile stations (e.g., BS 102) which cannot be supported by the base station from accessing the system. The field 506 (SID) indicates system identification. The base station shall set this field to the system identification number for this system. The field 508 (MD) indicates network identification. This field serves as a sub-identifier of a system as defined by the owner of the SID. The field 510 (PILOT_PN) indicates the pilot PN sequence offset index. The base station shall set this field to the pilot PN sequence offset for this base station, in units of 64 PN chips. The field 512 (LC_STATE) indicates the long code state. The base station shall set this field to the long code state at the time given by the SYS_TIME field of this message. The field 514 (SYS_TIME) indicates the system time. The field 516 (LP_SEC) indicates the number of leap seconds that have occurred since the start of System Time. The field 518 (LTM_OFF) indicates the offset of local time from System Time. The field 520 (DAYLT) is a daylight savings time indicator. If daylight savings time is in effect, the base station sets this field to 1; otherwise, the base station sets this field to 0.

### Daylight Savings Time

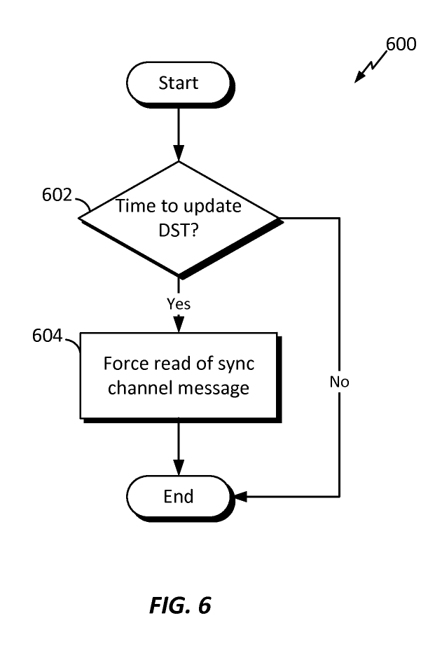

Daylight savings time (DST) generally takes effect at 2 am, twice a year. To be sure that the MS 102 maintains synchronization upon daylight savings time changes, in one aspect, the MS 102 may be configured to have knowledge on the dates of interest (dates of daylight saving times changes) and accordingly performs a read (e.g., force read) of the sync channel message 500 at a suitable time based on that knowledge. FIG. 6 is a flow chart illustrating a process 600 for updating daylight savings time at the MS 102 in accordance with an aspect of the disclosure. In step 602, the MS 102 may be configured to determine whether or not DST should be updated or synchronized. For example, the MS 102 may be in the idle state 304 and is configured to update DST shortly after DST updates may occur (e.g., based on the mobile's internal time and knowledge on the DST update schedules). In another example, the MS 102 is configured to retrieve the sync channel message 500 at a convenient point during its sleep timeline, for example, every day or other suitable predetermined time. In step 604, the MS 102 performs a force read of the sync channel message 500 to synchronize DST, for example, based on the DAYLT field 520.

### Local Time Zone Change

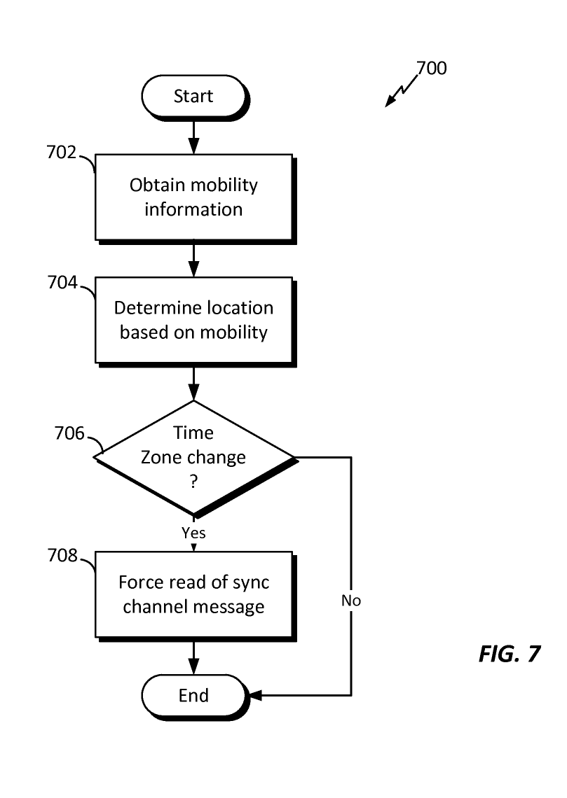

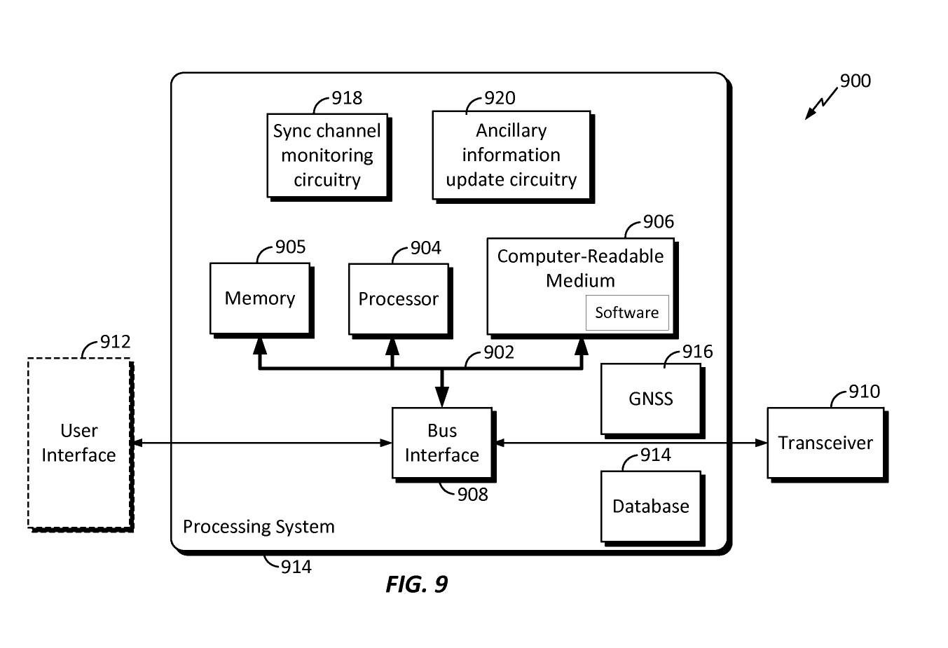

Local time zone offsets generally are dependent upon mobility of the MS 102 among different time zones. FIG. 7 is a flow chart illustrating a process 700 for updating local time zone information at the MS 102 in accordance with an aspect of the disclosure. In step 702, the MS 102 obtains its mobility information. For example, the MS 102 may obtain its mobility information by monitoring messages or data (e.g., messages 106) on overhead/signaling channels (e.g., the paging channel). Overhead messages are sent by the BS 104 on the paging channel or the broadcast control channel to communicate base-station-specific and system-wide information to the MS 102. These overhead messages typically indicate the base station's latitude/longitude information. In another aspect, the MS 102 may utilize information from its global navigation satellite system (e.g., GNSS 916 of FIG. 9) stack for clues about larger movements or mobility. In step 704, the MS 102, by utilizing the obtained mobility information, can determine its location. In step 706, the MS 102 determines whether or not a time zone change has occurred based on its current location and previous location. In one aspect, the MS 102 may have a database (e.g., database 914 of FIG. 9) of time zone areas. Therefore, the MS 102 may determine its current time zone using the database based on its current location. If the MS 102 determines that a time zone change has occurred, in step 708, it performs a force read of the sync channel message 500 to retrieve the local time zone offset (e.g., LTM_OFF 518), for example.

In another example, the MS 102 may utilize a heuristic method based upon idle or traffic handoff transitions history to determine its mobility, in order to infer that the sync channel should be monitored or read at the next opportune time. For example, based on certain handoff behavior, the MS 102 may determine that the probability of movement to a different time zone may be relatively high, in which case it may perform a force read of the sync channel to retrieve the sync channel message 500.

### Leap Seconds

Leap seconds are generally updated infrequently, according to no fixed schedule. Therefore, it is not easy to predict when a leap second might be used. Thus, in one aspect, the MS 102 may let leap seconds update as a natural consequence of reading the sync channel message for either of the two above reasons (DST or time zone update).

### Monitoring in Parallel with Other Channels

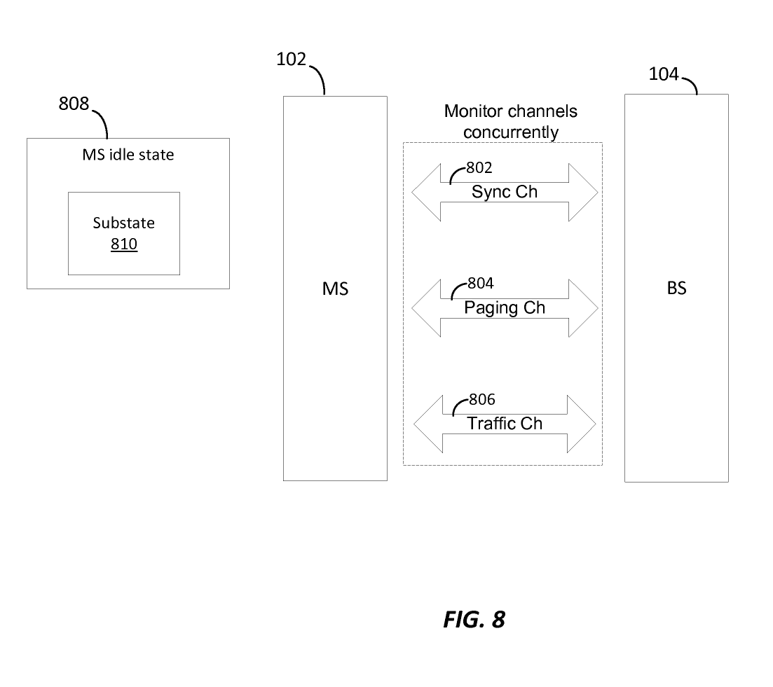

FIG. 8 is a conceptual diagram illustrating a MS 102 configured to monitor a sync channel 802 concurrent with a monitoring of a paging channel 804 and/or a traffic channel 806 in accordance with an aspect of the disclosure. In FIG. 8, the MS 102 is in wireless communications with a BS 104. For example, the MS 102 may concurrently or simultaneously monitor the sync channel 802 in parallel with the paging channel 804 and/or the traffic channel 806. This may reduce or minimize negative impact to existing power and paging performance at the MS 102. Thus, in one example, the MS 102 may monitor the sync channel 802 (e.g., F-SYNC) to retrieve the sync channel message 500, and it concurrently monitors the paging channel and/or traffic channel. For example, the MS 102 may concurrently monitor the sync channel 802 in parallel with being in an idle state or a traffic state. In one example, the MS 102 may have a new substate for retrieving the sync channel message while concurrently monitoring the paging/traffic channel. For example, referring to FIG. 8, an MS idle state 808 may have a new substate 810 that provide functions similar to those of the sync acquisition substate 406. The MS idle state 808 may be used as the MS idle state 304 in FIG. 3.

FIG. 9 is a conceptual diagram illustrating an example of a hardware implementation for a mobile station 900 employing a processing system 914. The mobile station 900 may be used as the MS 102 to communicate with the BS 104. In accordance with various aspects of the disclosure, an element, or any portion of an element, or any combination of elements may be implemented with a processing system 914 that includes one or more processors 904. Examples of processors 904 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing system 914 may be implemented with a bus architecture, represented generally by the bus 902. The bus 902 may include any number of interconnecting buses and bridges depending on the specific application of the processing system 914 and the overall design constraints. The bus 902 links together various circuits including one or more processors (represented generally by the processor 904), a memory 905, and computer-readable media (represented generally by the computer-readable medium 906). The bus 902 may also link various other circuits such as timing sources, peripherals, voltage regulators, and power management circuits, which are well known in the art, and therefore, will not be described any further. A bus interface 908 provides an interface between the bus 902 and a communication interface 910 (e.g., a transceiver). The interface 910 provides a means for communicating with various other apparatus over a transmission medium. Depending upon the nature of the apparatus, a user interface 912 (e.g., keypad, display, speaker, microphone, joystick) may also be provided.

The processor 904 is responsible for managing the bus 902 and general processing, including the execution of software stored on the computer-readable medium 906. The software, when executed by the processor 904, causes the processing system 914 to perform the various functions described throughout this disclosure for any particular apparatus. The computer-readable medium 906 may also be used for storing data that is manipulated by the processor 904 when executing software.

In one aspect, the processing system 914 includes a database 914 that includes time zone information. In some aspects, the database 914 may be stored in the memory 905 or the computer-readable medium 906. In one aspect, the processing system 914 includes a global navigation satellite system (GNSS) 916 (e.g., Global Positioning System) that can provide location information based on satellite signals. The processing system 914 may also include a sync channel monitoring circuitry 918 and an ancillary information update circuitry 920. The sync channel monitoring circuitry 918 may be utilized to force read the sync channel (e.g., in steps 604 and 708) to retrieve the sync channel message 500. The ancillary information update circuitry 920 may be utilized to update information on daylight savings time, time zone, or leap seconds at the processing system 914.

One or more processors 904 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 906. The computer-readable medium 906 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 906 may reside in the processing system 914, external to the processing system 914, or distributed across multiple entities including the processing system 914. The computer-readable medium 906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

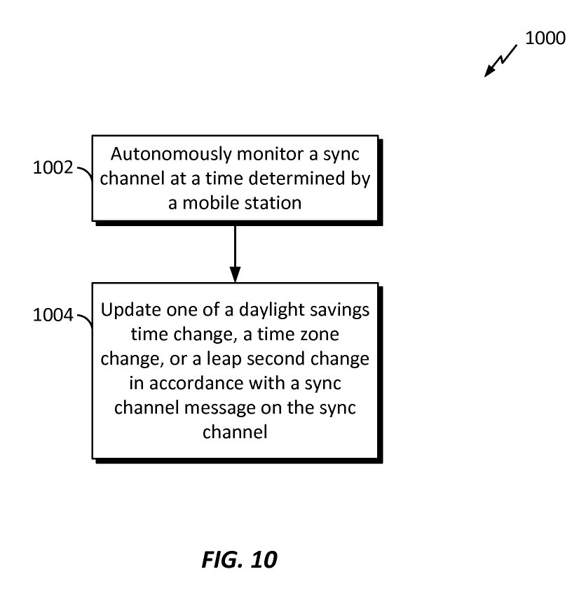

FIG. 10 is a flowchart illustrating a method 1000 of wireless communication operable at a mobile station 102 utilizing IS-2000 1x in accordance with an aspect of the disclosure. In step 1002, a mobile station 102 autonomously monitors a sync channel (e.g., 802 of FIG. 8) in accordance with location information determined by the mobile station, at a time independently determined by the mobile station. In step 1004, the mobile station 102 updates one of a daylight savings time change, a time zone change, or a leap second change in accordance with a sync channel message (e.g., 500 of FIG. 5) on the sync channel.

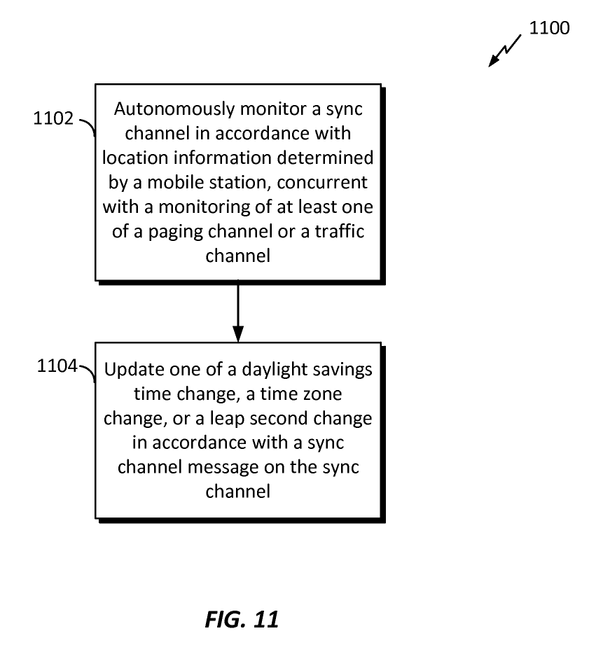

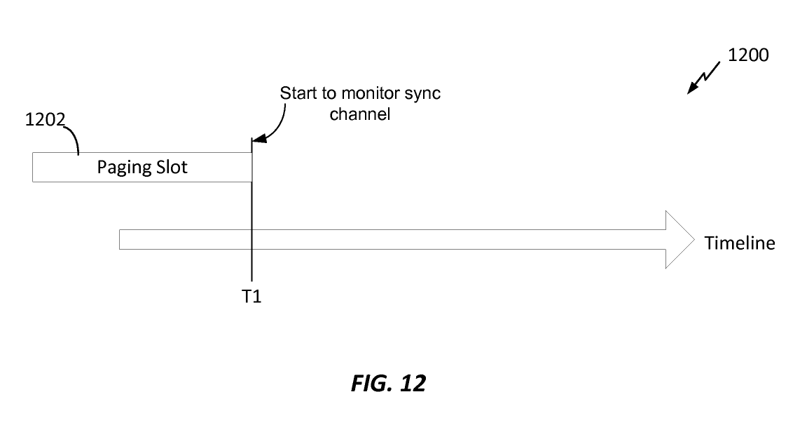

FIG. 11 is a flowchart illustrating a method 1100 of wireless communication operable at a mobile station 102 utilizing IS-2000 1x in accordance with an aspect of the disclosure. In step 1102, a mobile station 102 autonomously monitors a sync channel (e.g., 802 of FIG. 8) in accordance with location information determined by the mobile station, concurrent with a monitoring of at least one of a paging channel (e.g., 804 of FIG. 8) or a traffic channel (e.g., 806 of FIG. 8). In step 1104, the mobile station 102 updates one of a daylight savings time change, a time zone change, or a leap second change in accordance with a sync channel message (e.g., 500 of FIG. 5) on the sync channel. FIG. 12 is a drawing illustrating a timeline 1200 for autonomously monitoring a sync channel utilizing IS-2000 1x in accordance with an aspect of the disclosure. A mobile station (e.g., MS 102) autonomously monitors a sync channel message (e.g., message 500 of FIG. 5) in accordance with a predetermined schedule. For example, the mobile station monitors the sync channel message at a time T1 immediately after the end of a paging slot/interval 1202 to reduce the likelihood of missing pages.

Several aspects of a telecommunications system have been presented with reference to an IS-2000 1x system. As those skilled in the art will readily appreciate, various aspects described throughout this disclosure may be extended to other telecommunication systems, network architectures and communication standards.

By way of example, various aspects may be extended to other wireless communications system such as UMTS, TD-SCDMA and TD-CDMA systems. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication operable at a mobile station utilizing IS-2000 1x, comprising:
autonomously monitoring a sync channel in accordance with location information at a time independently determined by the mobile station; and
updating one of a daylight savings time change, a time zone change, or a leap second change in accordance with a sync channel message on the sync channel.

2. The method of claim 1, further comprising determining the location information in accordance with a history of handoffs of the mobile station including a number of handoffs within a period of time and a pattern of handoffs among a plurality of base stations.

3. The method of claim 2, further comprising retrieving the sync channel message if the number of handoffs within a period of time is greater than a threshold value irrespective of the determined location information.

4. The method of claim 1, wherein the autonomously monitoring comprises monitoring the sync channel concurrent with a monitoring of at least one of a paging channel or a traffic channel.

5. The method of claim 1, wherein the autonomously monitoring comprises retrieving the sync channel message according to a predetermined schedule.

6. The method of claim 5, wherein the predetermined schedule corresponds to changes in daylight savings time.

7. The method of claim 1, wherein the autonomously monitoring comprises monitoring the sync channel immediately after the end of a paging slot.

8. The method of claim 1, wherein the autonomously monitoring comprises determining to retrieve the sync channel message in accordance with information on an overhead channel.

9. The method of claim 8, wherein the overhead channel comprises at least one of a paging channel or a traffic channel.

10. The method of claim 8, wherein the information on the overhead channel comprises location information of a base station serving the mobile station.

11. The method of claim 1, wherein the location information corresponds to a location of a base station serving the mobile station.

12. The method of claim 1, wherein the location information corresponds to global navigation satellite system information received by the mobile station.

13. A method of wireless communication operable at a mobile station utilizing IS-2000 1x, comprising:
autonomously monitoring a sync channel in accordance with location information, concurrent with a monitoring of at least one of a paging channel or a traffic channel; and
updating one of a daylight savings time change, a time zone change, or a leap second change in accordance with a sync channel message on the sync channel.

14. The method of claim 13, wherein the autonomously monitoring comprises retrieving the sync channel message according to a predetermined schedule.

15. The method of claim 14, wherein the predetermined schedule corresponds to changes in daylight savings time.

16. The method of claim 13, wherein the location information corresponds to a location of a base station serving the mobile station.

17. The method of claim 13, wherein the location information corresponds to global navigation satellite system information received by the mobile station.

18. A mobile station for wireless communication utilizing IS-2000 1x, comprising:
means for autonomously monitoring a sync channel in accordance with location information at a time independently determined by the mobile station; and
means for updating one of a daylight savings time change, a time zone change, or a leap second change in accordance with a sync channel message on the sync channel.

19. The mobile station of claim 18, further comprising means for determining the location information in accordance with a history of handoffs of the mobile station including a number of handoffs within a period of time and a pattern of handoffs among a plurality of base stations.

20. The mobile station of claim 19, further comprising means for retrieving the sync channel message if the number of handoffs within a period of time is greater than a threshold value irrespective of the determined location information.

21. The mobile station of claim 18, wherein the means for autonomously monitoring comprises means for monitoring the sync channel concurrent with a monitoring of at least one of a paging channel or a traffic channel.

22. The mobile station of claim 18, wherein the means for autonomously monitoring comprises means for retrieving the sync channel message according to a predetermined schedule.

23. The mobile station of claim 22, wherein the predetermined schedule corresponds to changes in daylight savings time.

24. The mobile station of claim 18, wherein the means for autonomously monitoring is configured to monitor the sync channel immediately after the end of a paging slot.

25. The mobile station of claim 18, wherein the means for autonomously monitoring comprises means for determining to retrieve the sync channel message in accordance with information on an overhead channel.

26. The mobile station of claim 25, wherein the overhead channel comprises at least one of a paging channel or a traffic channel.

27. The mobile station of claim 25, wherein the information on the overhead channel comprises location information of a base station serving the mobile station.

28. The mobile station of claim 18, wherein the location information corresponds to a location of a base station serving the mobile station.

29. The mobile station of claim 18, wherein the location information corresponds to global navigation satellite system information received by the mobile station.

30. A mobile station for wireless communication utilizing IS-2000 1x, comprising:
means for autonomously monitoring a sync channel in accordance with location information, concurrent with a monitoring of at least one of a paging channel or a traffic channel; and
means for updating one of a daylight savings time change, a time zone change, or a leap second change in accordance with a sync channel message on the sync channel.

31. The mobile station of claim 30, wherein the means for autonomously monitoring comprises means for retrieving the sync channel message according to a predetermined schedule.

32. The mobile station of claim 31, wherein the predetermined schedule corresponds to changes in daylight savings time.

33. The mobile station of claim 30, wherein the location information corresponds to a location of a base station serving the mobile station.

34. The mobile station of claim 30, wherein the location information corresponds to global navigation satellite system information received by the mobile station.

35. A computer program product, comprising:
a computer-readable storage medium comprising code for causing a mobile station utilizing IS-2000 1x to:
autonomously monitor a sync channel in accordance with location information at a time independently determined by the mobile station; and
update one of a daylight savings time change, a time zone change, or a leap second change in accordance with a sync channel message on the sync channel.

36. A computer program product, comprising:
a computer-readable storage medium comprising code for causing a mobile station utilizing IS-2000 1x to:
autonomously monitor a sync channel in accordance with location information, concurrent with a monitoring of at least one of a paging channel or a traffic channel; and
update one of a daylight savings time change, a time zone change, or a leap second change in accordance with a sync channel message on the sync channel.

37. A mobile station for wireless communication utilizing IS-2000 1x, comprising:
at least one processor;
a communication interface coupled to the at least one processor; and
a memory coupled to the at least one processor,
wherein the at least one processor is configured to:
autonomously monitor a sync channel in accordance with location information at a time independently determined by the mobile station; and
update one of a daylight savings time change, a time zone change, or a leap second change in accordance with a sync channel message on the sync channel.

38. The mobile station of claim 37, wherein the at least one processor is further configured to determine the location information in accordance with a history of handoffs of the mobile station including a number of handoffs within a period of time and a pattern of handoffs among a plurality of base stations.

39. The mobile station of claim 38, wherein the at least one processor is further configured to retrieve the sync channel message if the number of handoffs within a period of time is greater than a threshold value irrespective of the determined location information.

40. The mobile station of claim 37, wherein the at least one processor is further configured to autonomously monitor the sync channel concurrent with a monitoring of at least one of a paging channel or a traffic channel.

41. The mobile station of claim 37, wherein for the autonomously monitoring, the at least one processor is further configured to retrieve the sync channel message according to a predetermined schedule.

42. The mobile station of claim 41, wherein the predetermined schedule corresponds to changes in daylight savings time.

43. The mobile station of claim 37, wherein for the autonomously monitoring, the at least one processor is further configured to monitor the sync channel immediately after the end of a paging slot.

44. The mobile station of claim 37, wherein for the autonomously monitoring, the at least one processor is further configured to determine to retrieve the sync channel message in accordance with information on an overhead channel.

45. The mobile station of claim 44, wherein the overhead channel comprises at least one of a paging channel or a traffic channel.

46. The mobile station of claim 44, wherein the information on the overhead channel comprises location information of a base station serving the mobile station.

47. The mobile station of claim 37, wherein the location information corresponds to a location of a base station serving the mobile station.

48. The mobile station of claim 37, wherein the location information corresponds to global navigation satellite system information received by the mobile station.

49. A mobile station for wireless communication utilizing IS-2000 1x, comprising:
at least one processor;
a communication interface coupled to the at least one processor; and
a memory coupled to the at least one processor,
wherein the at least one processor is configured to:
autonomously monitor a sync channel in accordance with location information, concurrent with a monitoring of at least one of a paging channel or a traffic channel; and
update one of a daylight savings time change, a time zone change, or a leap second change in accordance with a sync channel message on the sync channel.

50. The mobile station of claim 49, wherein for the autonomously monitoring, the at least one processor is further configured to retrieve the sync channel message according to a predetermined schedule.

51. The mobile station of claim 50, wherein the predetermined schedule corresponds to changes in daylight savings time.

52. The mobile station of claim 49, wherein the location information corresponds to a location of a base station serving the mobile station.

53. The mobile station of claim 49, wherein the location information corresponds to global navigation satellite system information received by the mobile station.
